(19) United States
(12) Patent Application Publication
(10) Pub. No.: US 2008/0149574 A1
(43) Pub. Date: Jun. 26, 2008

(54) Gas/Liquid Separator Assembly with Preseparator and Liquid Filter, and Methods

(76) Inventor: Brian READ, Eagan, MN (US)

Correspondence Address: MERCHANT & GOULD PC, P.O. BOX 2903, MINNEAPOLIS, MN, 55402-0903, US

(21) Appl. No.: 11/962,323

(22) Filed: Dec. 21, 2007

Related U.S. Application Data
(60) Provisional application No. 60/871,561, filed on Dec. 22, 2006.

(51) Int. Cl. C02F 9/02; B01D 37/00

(52) U.S. Cl. 210/806; 210/188; 210/767

(57) ABSTRACT

A gas/liquid (e.g., air/oil) separator assembly. The assembly has a vessel having a top plate, a separator element within the vessel, an aperture in the top plate for receiving the separator element therethrough, and a lid fitted to seal with the top plate and cover the separator element in the vessel. The lid may be configured for threaded attachment to the top plate. Methods of use and servicing are also provided.

This application claims priority to U.S. Provisional Application Ser. No. 60/871,561 titled GAS/LIQUID SEPARATOR ASSEMBLY WITH PRESEPARATOR AND LIQUID FILTER, AND METHODS filed on Dec. 22, 2006. The entire disclosure of U.S. Provisional Application Ser. No. 60/871,561 is incorporated by reference.

### FIELD OF THE INVENTION

The present disclosure relates to gas/liquid separators. The disclosure particularly concerns an assembly for a gas/liquid separation process, the assembly having a gas/liquid separator and a liquid filter. One particular, useful, application is as an air/oil separator for use with air compressors.

### BACKGROUND

Certain gas/liquid separator assemblies, such as those used with air compressors, include two general components, a vessel with a cover and a separator arrangement. In some assemblies, a single separator element is used as the separator arrangement, which is usually removable and replaceable from the vessel (i.e., serviceable). In other assemblies, multiple separator elements are used as the separator arrangement. For servicing, either a top plate or flange is removed from the vessel, providing access to the element(s) therein, or a bottom plate or flange is removed, allowing the element(s) to drop therefrom.

Most of these gas/liquid separation assemblies also include a liquid filter to remove particulate contaminant from the liquid.

In general, operation of a gas/liquid separator assembly involves directing a fluid stream (typically gas with entrained liquid therein) into the vessel. The gas flow is eventually directed through the serviceable separator element(s). Within the separator element(s), liquid in the stream is coalesced and drained from the stream. Periodically, the element(s) are removed and replaced; either the element(s) are removed from the vessel, or, the entire separator assembly is removed and replaced.

There is always room for improvements in gas/liquid separator assemblies.

### SUMMARY

The present disclosure provides gas/liquid separator assemblies, the assemblies having a first vessel with at least one removable and replaceable, i.e., serviceable, separator element present within the vessel. Also present in the assembly is a second vessel having at least one removable and replaceable, i.e., serviceable, liquid filter. The vessels are sufficiently small in volume to eliminate the requirement that the vessels are pressure vessels.

In use, the separator assembly separates liquid (e.g., oil) from a gas (e.g., air) stream in the first vessel. The liquid (e.g., oil) is then fed to the second vessel where it is filtered for use with downstream equipment, such as a compressor.

In one particular aspect, this disclosure is directed to a gas/liquid (e.g., air/oil) separator assembly comprising a first vessel having a first interior volume and a second vessel having a second interior volume, a separator element within the first interior and a liquid filter within the second interior.

These and various other features which characterize the separator assemblies of this disclosure are pointed out with particularity in the attached claims. For a better understanding of the separator assemblies of the disclosure, their advantages, their use and objectives obtained by their use, reference should be made to the drawings and to the accompanying description, in which there is illustrated and described preferred embodiments of the invention of this disclosure.

### BRIEF DESCRIPTION OF THE DRAWING

FIG. 1 is a top cross-sectional view of a first embodiment of a gas/liquid separator assembly of the present disclosure, taken along line 1-1 of FIG. 2.

FIG. 2 is a cross-sectional side view of the gas/liquid separator assembly of FIG. 1.

FIG. 3 is a cross-sectional side view of a second embodiment of a gas/liquid separator assembly of the present disclosure.

FIG. 4 is a top cross-sectional view of a third embodiment of a gas/liquid separator assembly of the present disclosure, taken along line 4-4 of FIG. 5.

FIG. 5 is a cross-sectional side view of the gas/liquid separator assembly of FIG. 4.

FIG. 6 is cross-sectional view of a fourth embodiment of a gas/liquid separator assembly of the present disclosure, taken along line 6-6 of FIG. 7.

FIG. 7 is cross-sectional side view of the gas/liquid separator assembly of FIG. 6.

FIGS. 8A-8C are cross-sectional side views of various inertial separator precleaners.

### DETAILED DESCRIPTION

In general, gas/liquid separator assemblies of the type of concern herein include a first vessel and an internally received, separator arrangement. The internally received separator arrangement generally has one or more separators (or separator elements). Each separator element includes a media pack, through which gas is passed. Each media pack typically includes layers of media for coalescing and draining liquid from the gas. The at least one separator element is removable and replaceable from the vessel, i.e., “serviceable”. The gas/liquid separator assemblies also include a liquid filter element within a second vessel.

In accordance with this disclosure, the first vessel has an interior volume and the second vessel has an interior volume, in fluid connection with the first interior volume. The one or more separator elements are positioned within the first vessel and one or more liquid filter elements are positioned within the second vessel. Each of the vessels is sufficiently small in dimension and volume to bring the vessels out of required pressure vessel standards.

A typical application for the gas/liquid (e.g., air/oil) separators of this disclosure is for a compressor arrangement. Such an apparatus is generally adapted for operation with internal pressures on the order of about 60 psi to 200 psi (about 4.2-14.06 kg/cm²), for example about 80-120 psi (about 5.6-8.44 kg/cm²), typically about 100 psi (about 7 kg/cm²). Because of the overall size and volume of the vessels, even with these internal operating pressures, the separator assembly does not have to be classified as a pressure vessel.

Examples of use for separator assemblies of this disclosure would be with compressors of 20 hp to 500 hp (about 14.9-373 Kw). The throughput for an air/oil separator for use with a compressor arrangement is typically measured in terms of volume of free air (i.e., non-compressed volume) passed through the separator assembly. A typical operating flow would be from on the order of 100 cubic feet per minute (47,000 cm³/s) up to several thousand cubic feet per minute (about 1 million cm³/s or more).

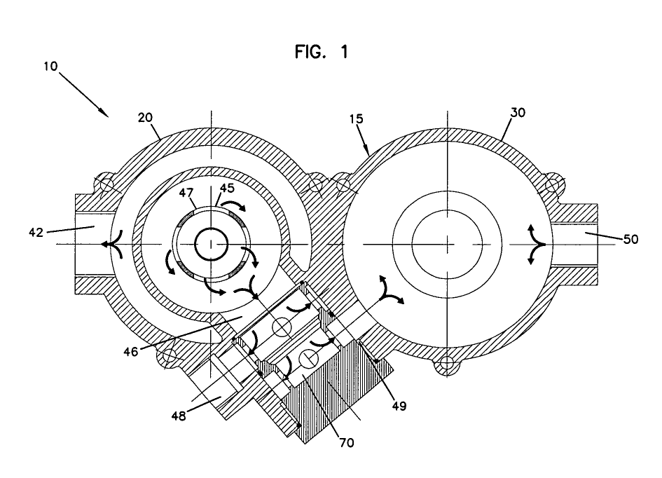

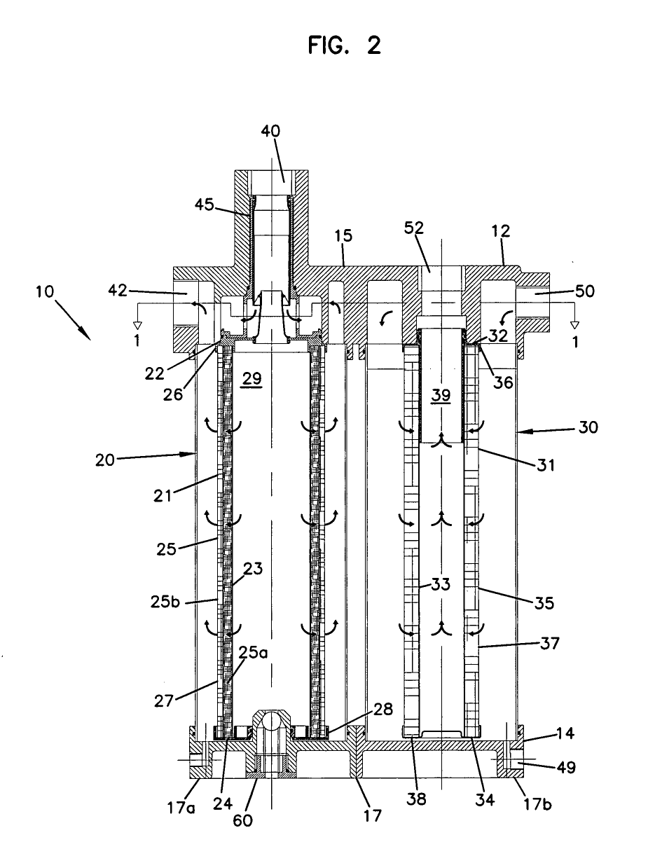

Herein, a first particular separator arrangement is shown in the accompanying Figures, particularly in FIGS. 1 and 2. Various alternate embodiments of separator arrangements are described throughout this disclosure and in other Figures. The techniques and principles described herein can be applied in a variety of systems of a variety of sizes, for use with a wide variety of equipment types and sizes (for example, a variety of compressors).

In the Figures, various embodiments of gas/liquid separators usable as an air/oil separator that includes a preferred assembly according to the present disclosure are depicted. The particular assemblies depicted in the Figures are configured for use with an internal pressure of about 100 psi (about 7 kg/cm²), and for use with a compressor having a rating of about 100-150 hp (74.6-112 Kw), for example about 125 hp (93 Kw). The throughput for such an arrangement would generally be on the order of about 250 cfm (about 118,000 cm³/s). It is understood that assemblies having other pressures, hp ratings and flows are within the scope of this disclosure.

In FIGS. 1 and 2, the reference number 10 generally designates a first embodiment of a gas/liquid separator assembly according to the present disclosure. Assembly 10 has a first end 12 and a second end 14. As illustrated in FIG. 2, when assembly 10 is in a “use” orientation, first end 12 is positioned above second end 14. In this position, first end 12 is a top end. Present at first end 12 is a head 15, such as of cast aluminum. Present at second end 14 is a lower end cap 17.

Connected to, and in this embodiment depending from head 15, are a first vessel 20 and a second vessel 30. First vessel 20 is in fluid communication with second vessel 30 via head 15. An internally received separator arrangement, in this instance comprising a single separator element 21, is present within first vessel 20. An internally received liquid filter, in this instance comprising a single filter 31, is present within second vessel 30.

Each vessel 20, 30 has an interior diameter of less than 6 inches (about 15.24 cm). Vessels having inside diameters of less than 6 inches are not subject to the ASME Section, VIII Pressure Vessels, Division 1 code requirements.

Additionally, for this embodiment, each vessel 20, 30, is no more than about 20 inches (about 51 cm) in length, often no more than about 19 inches (about 48.25 cm). The overall height of assembly 10 is no more than about 25 inches (about 63.5 cm).

Either end of assembly 10, either top end 12 or bottom end 14, may provide access to an interior of vessels 20, 30, via head 15 or lower end cap 17, respectively. In this embodiment, access is gained to the interior of vessels 20, 30 via bottom end 14, by removal of at least a portion of lower end cap 17. In this embodiment, lower end cap 17 has a first portion 17a proximate vessel 20 and a second portion 17b proximate vessel 30. As illustrated in FIG. 2, when assembly 10 is in a “use” orientation, top end 12 is positioned above second end 14. In this embodiment, separator element 21 and filter 31 are “bottom loading” into assembly 10, in that access is gained to element 21 and filter 31 via end cap portion 17a and end cap portion 17b, respectively, at second bottom end 14. Other designs for accessing separator element 21 and/or filter 31 are provided in alternate embodiments, discussed below.

Present within head 15 at top end 12 are an air/liquid inlet 40 and an air outlet 42, both in fluid communication with the interior of first vessel 20. A liquid outlet 48, in fluid communication with the interior of first vessel 20 is also present within head 15. Also within head 15 are an oil inlet 50 and an oil outlet 52, both in fluid communication with the interior of second vessel 30. Each of air/liquid inlet 40, air outlet 42, oil inlet 50 and oil outlet 52 are further discussed below.

Present within the interior of first vessel 20 is element 21, having a first end 22 and a second end 24. In this embodiment, first end 22 is an open end, providing fluid (e.g., gas) flow therethrough, whereas second end 24 is a closed end, closed to fluid (e.g., gas) flow therethrough. In this embodiment, element 21 has a length that extends generally the length of the open interior of first vessel 20.

Separator element 21 includes a media pack 25 (in this instance a cylindrical media pack) extending generally from first end 22 to second end 24 and having an interior surface 23 and an exterior surface 27. In this embodiment, element 21 has a first end cap 26 at first end 22 and a second end cap 28 at second end 24, and media pack 25 extends between end caps 26, 28. Media pack 25 defines, at least partially, an interior 29 of element 21. The particular separator arrangement shown in FIG. 2 has an in-to-out flow path. By this, it is meant that when the gas stream passes through media pack 25 of separator element 21, it passes from the interior of element 21 (defined and surrounded by media pack 25) through interior surface 23, through media pack 25 and exits via exterior surface 27. Access is gained to interior 29 via open end 22 of element 21.

Media pack 25 comprises media that facilitates coalescing of liquid from the gas stream. The specific construction of media pack 25 is not critical to the general principles of the separator assembly described herein, and is a matter of choice. In general, the size and construction of media pack 25 will be selected based upon such issues as the air flow, the level of efficiency desired, the amount of restriction acceptable, the lifetime of use preferred and the size of space available. Media packs for air/oil separators are described, for example in the U.S. Pat. No. 6,093,231; U.S. Pat. No. 6,136,016; PCT publication WO 99/47211; PCT publication WO 99/43412; U.S. Pat. No. 6,419,721; and U.S. Pat. No. 4,836,931, the complete disclosures of which are incorporated herein by reference. Various liner structures or scrim structures to facilitate assembly or operation can be used. The principles of these types of arrangements, can, for example, be applied for separator elements herein.

In the particular embodiment illustrated, media pack 25 has an inner layer 25a and an outer layer 25b. With the gas flow “in-to-out”, inner layer 25a is upstream of outer layer 25b, which is downstream. In such an “in-to-out” embodiment, inner layer 25a is a coalescing stage and outer layer 25b is a drain stage. In general, fine liquid particles carried in the gas stream coalesce in coalescing layer 25a. The coalesced liquid particles generally are driven into the drain layer 25b, and then drain from the drain layer 25b, aided by the force of gravity, toward bottom end 24 of element 20.

Present within the interior of second vessel 30 is liquid filter 31, having a first end 32 and a second end 34. In this embodiment, first end 32 is an open end, providing fluid (e.g., gas) flow therethrough, whereas second end 34 is a closed end, closed to fluid (e.g., gas) flow therethrough. In this embodiment, filter 31 has a length that extends generally the length of the open interior of second vessel 30.

Filter 31 includes an extension of media 35 (in this instance cylindrical media) extending generally from first end 32 to second end 34 and having an interior surface 33 and an exterior surface 37. In this embodiment, filter 31 has a first end cap 36 at first end 32 and a second end cap 38 at second end 34, and media pack 35 extends between end caps 36, 38. Media 35 defines, at least partially, an interior 39 of filter 31. The particular filter 31 shown in FIG. 2 has an out-to-in flow path. Access is gained to interior 39 via open end 32 of element 31.

Filter 31 and its media 35 can be conventional elements configured for filtering of the liquid. In most embodiments of this disclosure, filter 31 is an oil filter. The specific construction of filter 31 and its media 35 is not critical to the general principles of separator assembly 10 described herein, and is a matter of choice. In general, the size and construction of filter 31 will be selected based upon such issues as the liquid flow, the level of efficiency desired, the amount of restriction acceptable, the lifetime of use preferred and the size of space available.

In this embodiment, separator assembly 10 also includes an inertial preseparator 45 downstream of air/liquid inlet 40 yet upstream of separator element 21. Element 21 is sealing connected (i.e., sealed) to preseparator 45, in this embodiment, at first end 22 of element 21; this seal can be via an o-ring seal. Of course any of a variety of seal arrangements could be used at the juncture between element 21 and preseparator 45. For example, either radial seals or axial seals or both can be used.

Preseparator 45 provides initial separation of liquid from gas, upon gas/liquid flow entering through inlet 40; preseparator 44 uses inertial forces to separate the two phases. Preseparator 45 is configured and positioned so that when liquid and gases enter inlet 40, they are moved through an arcuate path thus imparting centrifugal forces to the liquid (denser than the gas) and thus separating the liquid from the gas. In the particular embodiment of FIG. 2, the gas/liquid flow enters axial (e.g., in a generally straight path) into the inertial separator 45. An example of a suitable axial flow inertial preseparator 45 is available from Donaldson Company Inc. under the tradename STRATA TUBE.

Through preseparator 45, the gas, with some liquid removed therefrom, continues vertically downwards to vessel 20 and element 21, whereas removed liquid drains along the outer surfaces of preseparator 45 and passes through apertures 47 (e.g., 4 equally spaced apertures 47 in the outer wall of preseparator 45) in a generally horizontal direction to a collection chamber 46 (FIG. 1) in head 15, which is in fluid connection to second vessel 30 via passage 49. In case of over filling of vessel 30 with liquid, a thermal control valve 70 present in head 15 detours liquid from apertures 47 to outlet 48, allowing bypassing of vessel 30 and filter element 31.

Many air/oil separator assemblies utilized with compressors, such as assembly 10, are used in circumstances in which the inlet flow includes not only oil particles or droplets entrained in gas, but also a large amount of bulk liquid oil flow. Such an oil flow into the separator assembly can be on the order of, for example, 8 to 100 gallons per minute (about 30-380 liters/minute). Thus, the assembly, such as assembly 10, is preferably configured to manage a large amount of bulk oil flow along with the gas flow and gas/liquid separation. Inertial preseparator 45 is configured to manage large amounts of liquid flow.

As mentioned above, assembly 10 includes gas flow or gas/liquid (e.g., air/oil) inlet 40, gas (e.g., air) outlet 42, liquid (e.g., oil) outlet 48, liquid (e.g., oil) inlet 50 and liquid (e.g., oil) outlet 52. Inlet 40 provides a flow path for incoming gas (with liquid entrained therein) into first vessel 20 and separator element 21. Outlet 42 provides a flow path for cleansed gas out of assembly 10 to downstream equipment. Outlet 48 provides a flow path for liquid separated via preseparator 45. Inlet 50 provides a flow path for incoming liquid into second vessel 30 and liquid filter 31. Outlet 52 provides a flow path for cleansed gas out of second vessel 30 to downstream equipment.

Generally outlets 42, 48, 52 are connected to piping, hoses, or the like to move air and liquid to their desired locations. Assembly 10 also includes a liquid (e.g., oil) drain 49, for example, for draining liquid from assembly 10, in particular, from second vessel 30.

In some embodiments, a pressure relief valve 60 or other structure may be present to inhibit overpressurization of vessel 20. Any suitable pressure relief valve 60 may be used.

In use, a gas/liquid combination stream enters assembly 10 through inlet 40, flowing in through preseparator 45 where the bulk liquid is removed. The bulk liquid drains to end 14 of assembly, and is removed via outlet 48. From preseparator 45, the gas (with some liquid remaining) flows in to the interior of element 21, first through first media layer 25a and then through second media layer 25b. Liquid within the stream is pushed through media pack 25 and collects on exterior surface 27 of media pack 25. For media pack 25 having layers 25a, 25b, liquid collects on the exterior surface of outer layer 25b. Facilitated by gravity, the liquid flows down toward second end 24, where it collects. Separated liquid drains from media pack 25 down toward second end 14 of assembly 10, where it is removed from assembly 10 via a scavenge connection. The cleansed air passes out from assembly 10 via outlet 42 in head 15.

In preseparator 45, the air/liquid stream is moved through an arcuate path imparting centrifugal forces to the liquid and thus separating the liquid. The air (with some entrained liquid) continues vertically downwards to vessel 20 and element 21, whereas removed liquid drains along the outer surfaces of preseparator 45 and passes out apertures (e.g., 4 equally spaced apertures in the outer surfaces) in a generally horizontal direction to collection chamber 46. Liquid may exit via outlet 48 and/or thermal control vale to second vessel 30.

Liquid (e.g., oil) enters assembly 10 through inlet 50 into second vessel 30. The liquid passes through filter 31, removing particulate contaminants. Filtered liquid passes out from assembly 10 via outlet 52 in head 15.

Either or both of separator element 21 and filter 31 can be removed and replaced (i.e., serviced), as necessary. In this embodiment of assembly 10, both element 21 and filter 31 can be removed via bottom end 14, by detaching end cap portions 17a, 17b from vessels 20, 30, respectively. When servicing assembly 10, either or both element 21 or filter 31 may be replaced, depending on the wear on the items.

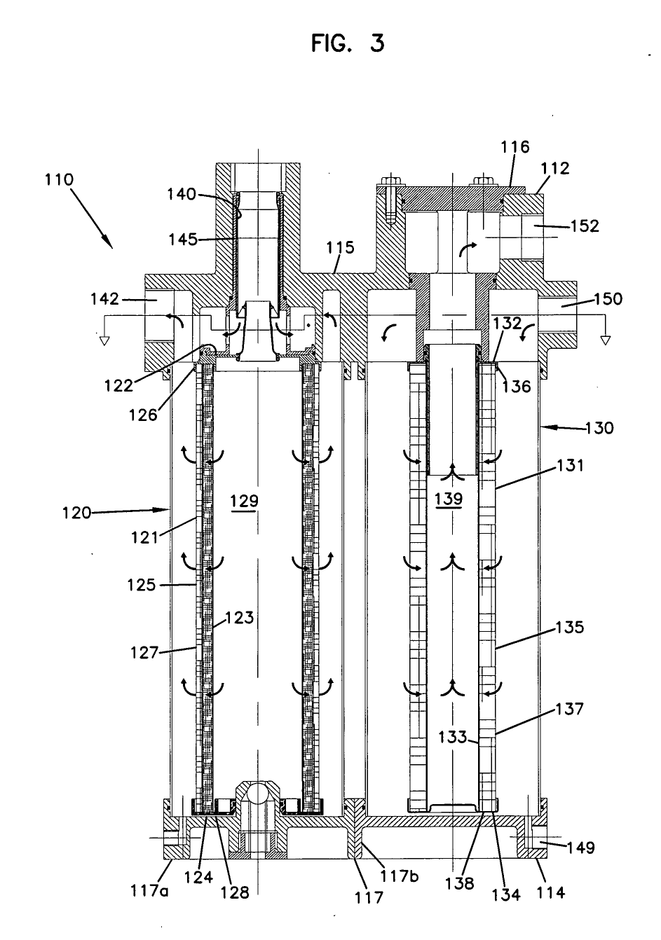

An alternate embodiment of a separator assembly according to the present disclosure is illustrated in FIG. 3; the reference number 110 generally designates a second embodiment of a gas/liquid separator assembly according to the present disclosure. In general, similar to assembly 10, assembly 110 has a first end 112 and a second end 114. As illustrated in FIG. 3, when assembly 110 is in a “use” orientation, first end 112 is positioned above second end 114. In this position, first end 112 is a top end. Present at first end 112 is a head 115 and present at second end 114 is a lower end cap 117. Lower end cap 117 has a first portion 117a proximate first vessel 20 and a second portion 117b proximate second vessel 30.

Connected to, and in this embodiment depending from head 115, are a first vessel 120 and a second vessel 130. First vessel 120 is in fluid communication with second vessel 130 via head 115. An internally received separator arrangement, in this instance comprising a single separator element 121, is present within first vessel 120. An internally received liquid filter, in this instance comprising a single filter 131, is present within second vessel 130.

Each vessel 120, 130 has an interior diameter less than 6 inches (about 15.24 cm). Additionally, for this embodiment, each vessel 120, 130, is no more than about 20 inches (about 51 cm) in length, often no more than about 19 inches (about 48.25 cm). Overall, the height of assembly 110 is no more than about 25 inches (about 63.5 cm).

In this assembly embodiment, access is gained to the interior of vessel 120 via lower end cap portion 117a, and to the interior of vessel 130 via top end 112, by removal of a flange or cover 116 from head 115.

Similar to assembly 10, present within head 115 are an air/liquid inlet 140 and an air outlet 142, both in fluid communication with first vessel 120. A liquid outlet 148, in fluid communication with first vessel 120 is also present within head 115. Also within head 115 are an oil inlet 150 and an oil outlet 152, both in fluid communication with second vessel 130.

Present within the interior of first vessel 120 is element 121, having a first end 122 and a second end 124. Separator element 121 includes a media pack 125 extending generally from first end 122 having a first end cap 126 to second end 124 having a second end cap 128, and having an interior surface 123 and an exterior surface 127. Media pack 125 extends between end caps 126, 128 and defines, at least partially, an interior 129 of element 121.

Present within the interior of second vessel 130 is liquid filter 131, having a first end 132 and a second end 134. Filter 131 includes an extension of media 135 extending generally from first end 132 with first end cap 136 to second end 134 with second end cap 138 and having an interior surface 133 and an exterior surface 137. Media 135 defines, at least partially, an interior 139 of filter 131. The particular filter 131 shown in FIG. 3 has an out-to-in flow path.

In this embodiment, similar to assembly 10, separator assembly 110 also includes an inertial preseparator 145 downstream of air/liquid inlet 140 yet upstream of element 121. Preseparator 145 is configured for axial flow therethrough.

Assembly 110 separates liquid from gas in the same manner as assembly 10, described above. Assembly 110 differs from assembly 10 in that head 115 is openable to allow access to filter 131 and thus remove filter 131 from its vessel 130 through top end 112 of assembly 110.

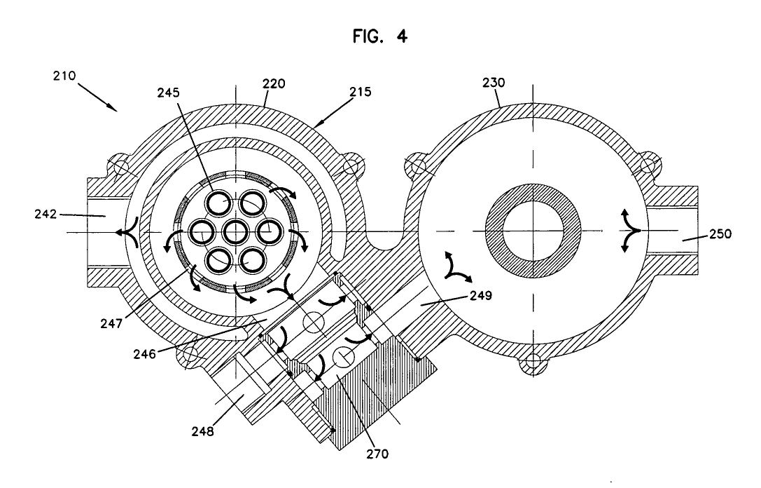

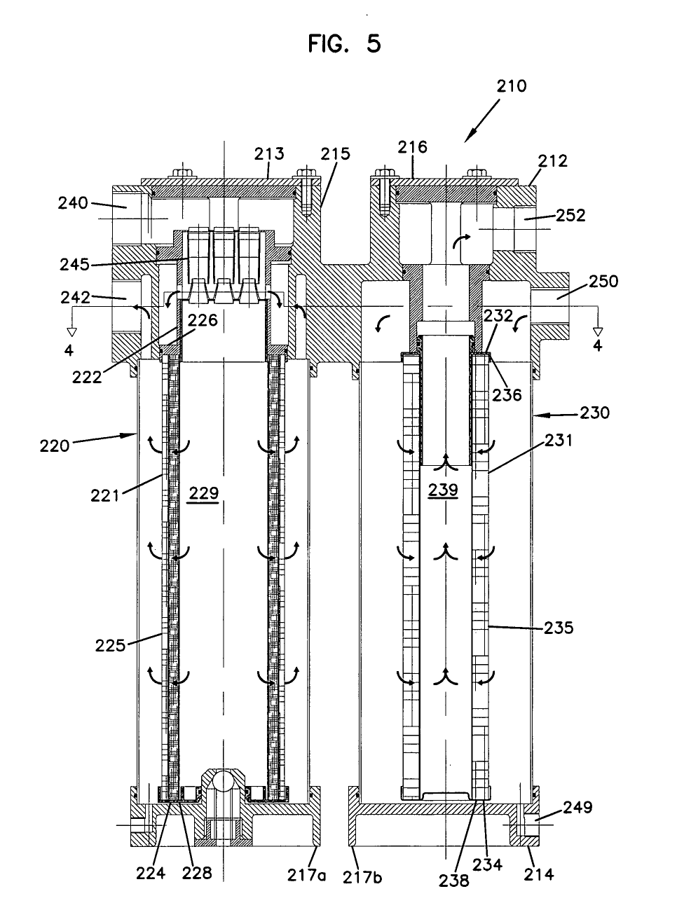

Yet another embodiment of a separator assembly according to the present disclosure is illustrated in FIGS. 4 and 5; the reference number 210 generally designates a third embodiment of a gas/liquid separator assembly according to the present disclosure. In general, similar to assembly 10 and 110, assembly 210 has a first end 212 and a second end 214. As illustrated in FIG. 5, when assembly 210 is in a “use” orientation, first end 212 is positioned above second end 214. In this position, first end 212 is a top end. Present at first end 212 is a head 215 that connects with both vessel 220 and vessel 230. Head 215 includes a first plate or flange 213 for access to vessel 220 and a second plate or flange 216 for access to vessel 230. Present at second end 214 is a lower end cap 217a that connects with vessel 220 and a lower end cap 217b that connects with vessel 230.

Connected to, and in this embodiment depending from head 215, are a first vessel 220 and a second vessel 230. First vessel 220 is in fluid communication with second vessel 230 via head 215. An internally received separator arrangement, in this instance comprising a single separator element 221, is present within first vessel 220. An internally received liquid filter, in this instance comprising a single filter 231, is present within second vessel 230.

Each vessel 220, 230 has an interior diameter less than 6 inches (about 15.24 cm). The overall height of assembly 210 is no more than about 24 inches (about 61 cm).

In this assembly embodiment, access is gained to the interior of vessel 220 via bottom end 214, and to the interior of vessel 230 via top end 212.

Similar to assembly 10 and assembly 110, present within head 215 are an air/liquid inlet 240 and an air outlet 242, both in fluid communication with first vessel 220. A liquid outlet 248, in fluid communication with first vessel 220 is also present within head 215. Also within head 215 are an oil inlet 250 and an oil outlet 252, both in fluid communication with second vessel 230.

Present within the interior of first vessel 220 is separator element 221, having a first end 222 and a second end 224. Element 221 includes a media pack 225 extending generally from first end 222 having a first end cap 226 to second end 224 having a second end cap 228. Media pack 225 extends between end caps 226, 228 and defines, at least partially, an interior 229 of element 221.

Present within the interior of second vessel 230 is liquid filter 231, having a first end 232 and a second end 234. Filter 231 includes an extension of media 235 extending generally from first end 232 with first end cap 236 to second end 234 with second end cap 238. Media 235 defines, at least partially, an interior 239 of filter 231. Filter 231 has an out-to-in flow path through media 235.

In this embodiment, separator assembly 210 includes a plurality of inertial preseparators 245 downstream of air/liquid inlet 240 yet upstream of element 221. Preseparators 245 are configured for axial flow therethrough. Compared to preseparators 45 and 145, preseparators 245 are shorter in their axial length and have a small diameter. In this embodiment, seven preseparators 245 are provided whereas both assemblies 10, 100 had one preseparator 45, 145, respectively. Additionally, apertures 247 (e.g., 8 equally spaced apertures 247) provide fluid flow of separated liquid from preseparators 245 to collection chamber 246, which is in fluid connection to second vessel 230 via passage 249. In case of over filling of vessel 230 with liquid, a thermal control valve 270 present in head 215 detours liquid from apertures 247 to outlet 248, allowing bypassing of vessel 230 and filter element 231.

Assembly 210 separates liquid from gas in the same manner as assemblies 10, 110 described above.

The previously discussed separator assemblies 10, 110, 210 have the two vessels 20, 30, 120, 130, 220, 230 positioned generally parallel to each other, both depending from head 15, 115, 215, respectively, in the same general direction.

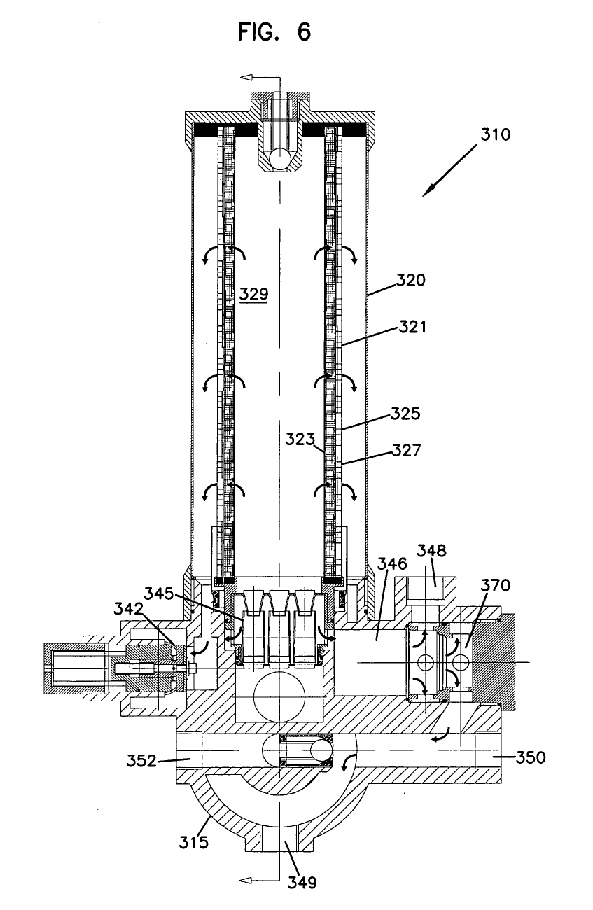

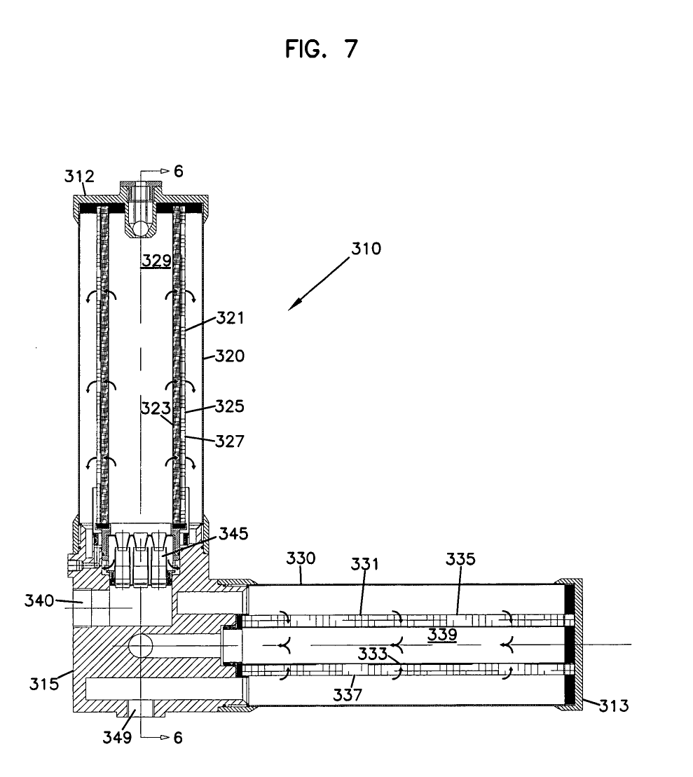

FIGS. 6 and 7 illustrate a separator assembly that has the separator element not parallel to, and not extending in the same direction as, the liquid filter element. In FIGS. 6 and 7, a separator assembly 310 is illustrated that has the separator element and the liquid filter element generally orthogonal to one another.

Separator assembly 310 includes a head 315 and a first vessel 320 and a second vessel 330 in fluid connection via head 315. The distal end of vessel 320 from head 315 is end 312, and the distal end of vessel 330 from head 315 is end 313. In this embodiment, vessel 320 is configured with end 312 positioned above head 315, and vessel 330 is configured with end 313 generally level with head 315.

An internally received separator arrangement, in this instance comprising a single separator element 321, is present within first vessel 320. An internally received liquid filter, in this instance comprising a single filter 331, is present within second vessel 330. Each vessel 320, 330 has an interior diameter less than 6 inches (about 15.24 cm). In this embodiment, access is gained to the interior of vessels 320, 330 and element 321 and filter 331 by removing vessels 320, 330 from head 315, e.g., by rotation, e.g., for a partial turn, one turn, or multiple turns.

Present within head 315 are an air/liquid inlet 340 (FIG. 7) and an air outlet 342 (FIG. 6), both in fluid communication with first vessel 320. A liquid outlet 348 (FIG. 6) in fluid communication with first vessel 320 is also present within head 315. Also within head 315 are an oil inlet 350 and an oil outlet 352, both in fluid communication with second vessel 330. Each of air/liquid inlet 340, air outlet 342, oil inlet 350 and oil outlet 352 are further discussed below.

Present within the interior of first vessel 320 is element 321, generally similar to elements 21, 121, 221 described above. Separator element 321 includes a media pack 325 having an interior surface 323 and an exterior surface 327. Media pack 325 defines, at least partially, an interior 329 of element 321. The particular separator arrangement shown in FIGS. 6 and 7 has an in-to-out flow path, with the flow entering vessel 320 in a generally upward, vertical manner.

Present within the interior of second vessel 330 is liquid filter 331, generally similar to filters 31, 131, 231 described above. Filter 331 includes an extension of media 335 having an interior surface 333 and an exterior surface 337. Media 335 defines, at least partially, an interior 339 of filter 331. The particular filter 331 shown in FIG. 7 has an out-to-in flow path, with the liquid entering vessel 330 in a generally horizontal manner.

In this embodiment, similar to assembly 210 of FIGS. 4 and 5, separator assembly 310 includes an inertial preseparator 345 that comprises a plurality of preseparators. Preseparators 345 are oriented so that the gas/liquid flow passes therethrough from inlet 340 in a vertical, bottom to top direction. The gas progresses upward and passes through separator element 321 from surface 323 to surface 327 and exits via outlet 342 (FIG. 6). The separated liquid drains downward to a collection chamber 346 in head 315, which is in fluid connection to second vessel 330.

In use, a gas/liquid combination stream enters assembly 310 through inlet 340, flowing upward through preseparator 345 where the bulk liquid is removed. The bulk liquid drains to head 315 and is removed via outlet 349. From preseparator 345, the gas (with some liquid remaining) flows in to the interior of element 321 and through media pack 335. Facilitated by gravity, liquid separated by element 321 flows down toward head 315, where it collects in collection chamber 346. Liquid may exit via outlet 348 and/or via thermal control valve 370 to second vessel 330. The cleansed gas passes out from assembly 310 via outlet 342.

Liquid (e.g., oil) enters assembly 310 through inlet 350 in head 315 into second vessel 330. The liquid passes through filter 331, removing particulate contaminants. Filtered liquid passes out from assembly 310 via outlet 352 in head 315.

Either or both of separator element 321 and filter 331 can be removed and replaced (i.e., serviced), as necessary. In this embodiment of assembly 310, both element 321 and filter 331 can be removed by removing vessel 230, 330 from head 215, for example, by rotating.

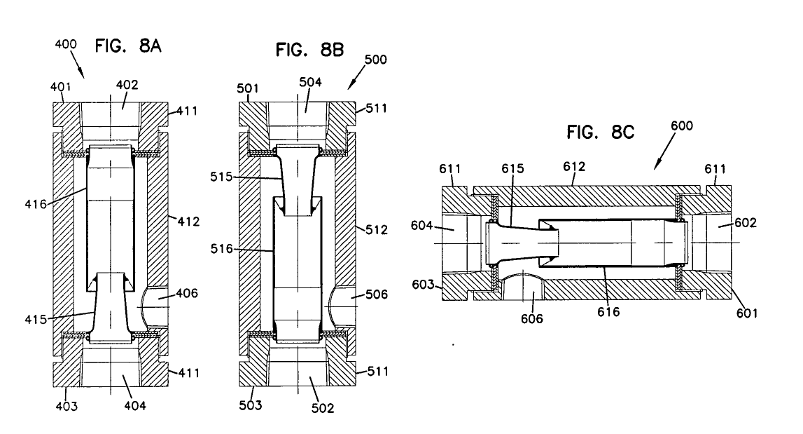

FIGS. 8A, 8B and 8C provide three embodiments of suitable inertial separators suitable as preseparators in the assemblies of this disclosure.

FIG. 8A illustrates an inertial separator 400 having a first end 401 (in this orientation also a top end) and a second end 403 (in this orientation also a bottom end). In this orientation, the gas/liquid stream being separated flows in a generally vertical direction. Separator 400 includes an inlet 402 for receiving the stream to be separated. Separator 400 includes a gas outlet 404 and a liquid outlet 406 to expel the resulting separated streams. Liquid outlet 406 is positioned closer to bottom end 403 than to top end 401. In this embodiment, separator 400 is configured to have the gas/liquid stream moving vertically downward.

Separator 400 includes optional adaptors 411, in this embodiment one positioned at each end 401, 403 of separator 400. A body 412 forms the main portion of separator 400, body 412 having a tube 415 and tube assembly 416 therein. Tube 415 has a cross-sectional shape or size that varies along its length. In many embodiments, tube 415 is conical or tapered in the direction opposite of gas flow; that is, the gas enters a smaller cross-sectional area of tube 415 and exits a larger cross-sectional area of tube 415.

Tube 415 and tube assembly 416 are configured and positioned so that when liquid and gases enter via inlet 402, they are moved through an arcuate path imparting centrifugal forces to the liquid and thus separating the liquid from the gas. The separated liquid drains via outlet 406.

FIG. 8B illustrates an inertial separator 500 having a first end 501 (in this orientation also a top end) and a second end 503 (in this orientation also a bottom end). In this orientation, the gas/liquid stream being separated flows in a generally vertical direction. Separator 500 includes an inlet 502 for receiving the stream to be separated. Separator 500 includes a gas outlet 504 and a liquid outlet 506 to expel the resulting separated streams. Liquid outlet 506 is positioned closer to bottom end 503 than to top end 501. In this embodiment, separator 500 is configured to have the gas/liquid stream moving vertically upward.

Similar to separator 400, separator 500 includes optional adaptors 511, in this embodiment one positioned at each end 501, 503 of separator 500. A body 512 forms the main portion of separator 500, body 512 having a tube 515 and tube assembly 516 therein. Tube 515 has a cross-sectional shape or size that varies along its length. In many embodiments, tube 515 is conical or tapered in the direction opposite of gas flow; that is, the gas enters a smaller cross-sectional area of tube 515 and exits a larger cross-sectional area of tube 515.

Tube 515 and tube assembly 516 are configured and positioned so that when liquid and gases enter via inlet 502, they are moved through an arcuate path imparting centrifugal forces to the liquid and thus separating the liquid from the gas. The separated liquid drains via outlet 506.

FIG. 8C illustrates an inertial separator 600 having a first end 601 and a second end 603. In this orientation, the gas/liquid stream being separated flows in a generally horizontal direction. Separator 600 includes an inlet 602 for receiving the stream to be separated. Separator 600 includes a gas outlet 604 and a liquid outlet 606 to expel the resulting separated streams. In this embodiment, separator 600 is configured to have the gas/liquid stream moving horizontally.

Similar to separators 400, 500, separator 600 includes optional adaptors 611, in this embodiment one positioned at each end 601, 603 of separator 600. A body 612 forms the main portion of separator 600, body 612 having a tube 615 and tube assembly 616 therein. Tube 615 has a cross-sectional shape or size that varies along its length. In many embodiments, tube 615 is conical or tapered in the direction opposite of gas flow; that is, the gas enters a smaller cross-sectional area of tube 615 and exits a larger cross-sectional area of tube 615.

Tube 615 and tube assembly 616 are configured and positioned so that when liquid and gases enter via inlet 602, they are moved through an arcuate path imparting centrifugal forces to the liquid and thus separating the liquid from the gas. The separated liquid drains via outlet 606.

Various embodiments of separator assemblies have been discussed herein. The separator assemblies and configured in a manner to avoid having the vessels having the separator elements and the liquid filters therein meet ASME Section, VIII Pressure Vessels, Division 1 code requirements. The inclusion of a preseparator, such as an inertial separator, upstream of the separator element facilitates this design by removing a large quantity of liquid from the gas/liquid stream prior to the stream reaching the separator element.

It is understood that the various embodiments, details and constructions of the assemblies and their features described above and illustrated in the attached Figures may be interchanged among the various embodiments while remaining within the scope of the invention. Additionally, it is understood that various modifications could be made to any of the assemblies and/or elements described herein above while remaining within the scope of the invention.

The techniques described herein and on the following pages can apply to a variety of equipment types, with a variety of sizes and specific configurations. The general characterizations herein are meant to be examples.

What is claimed is:

1. A gas/liquid separator assembly comprising:
(a) a first vessel and a second vessel, each having an interior in fluid communication with each other;
(b) a separator element within the first vessel, the element having an open end and a closed end, a media pack extending from the open end to the closed end;
(c) an inertial separator in the first vessel in fluid communication with the separator element; and
(d) a liquid filter within the second vessel.

2. The separator assembly of claim 1, wherein the inertial separator is connected to the separator element.

3. The separator assembly of claim 2, wherein the inertial separator comprises a plurality of inertial separators.

4. The separator assembly of claim 2, further comprising a head, wherein the first vessel and the second vessel are connected to the head.

5. The separator assembly of claim 4, wherein at least one of the first vessel and the second vessel are removably connected to the head.

6. The separator assembly of claim 4, wherein the first vessel is generally parallel to the second vessel.

7. The separator assembly of claim 1, wherein each of the first vessel and the second vessel have an inner diameter less than 6 inches.

8. A gas/liquid separator assembly comprising:
(a) a first vessel having an inner diameter less than 6 inches;
(b) a separator element within the first vessel;
(c) a second vessel having an inner diameter less than 6 inches, the second vessel having an interior in fluid communication with the interior of the first vessel; and
(d) a liquid filter within the second vessel.

9. The separator assembly of claim 8, further comprising
(a) an inertial separator in the first vessel in fluid communication with the separator element.

10. The separator assembly of claim 8, the separator element comprising a drain layer and a coalescing layer.

11. A method of removing liquid from a gas/liquid stream comprising:
(a) passing the gas/liquid stream through a separator element within a first vessel having an inner diameter of no more than 6 inches diameter to provide a liquid stream and a gas stream.

12. The method of claim 11, further comprising passing the liquid stream through a liquid filter.

13. A method of removing liquid from a gas/liquid stream comprising:
(a) passing the gas/liquid stream through an inertial separator and then through a separator element within a first vessel to provide a liquid stream and a gas stream.

14. The method of claim 13, further comprising passing the liquid stream through a liquid filter.

15. The method of claim 13, comprising passing the gas/liquid stream through a plurality of inertial separators.
